(19) United States
(12) Patent Application Publication
(10) Pub. No.: US 2010/0318719 A1
(43) Pub. Date: Dec. 16, 2010

(54) METHODS, MEMORY CONTROLLERS AND DEVICES FOR WEAR LEVELING A MEMORY

(75) Inventors: Brady L. Keays, Half Moon Bay, CA (US); Wanmo Wong, Menlo Park, CA (US)

Correspondence Address: BROOKS, CAMERON & HUEBSCH , PLLC, 1221 NICOLLET AVENUE, SUITE 500, MINNEAPOLIS, MN, 55403, US

(73) Assignee: MICRON TECHNOLOGY, INC., Boise, ID (US)

(21) Appl. No.: 12/483,712

(22) Filed: Jun. 12, 2009

(51) Int. Cl. G06F 12/02; G06F 12/00

(52) U.S. Cl. 711/103; 711/E12.001; 711/E12.008

(57) ABSTRACT

The present disclosure includes methods, memory controllers and devices for wear leveling a memory. One method embodiment includes selecting, in at least a substantially random manner, a number of memory locations as at least a portion of a sample subset, the sample subset including fewer than all memory locations of the memory. A memory location having a particular wear level characteristic is identified from among the sample subset of memory locations, and data is written to the memory location identified from among the sample subset.

### BACKGROUND

A memory device can be provided as internal, semiconductor, integrated circuits in computers or other electronic devices. A memory device can also be configured to be a stand-alone device external to a particular computer with communication bus plug-in connectivity. There are many different types of memory (e.g., memory cells) used in memory devices, including random-access memory (RAM), read only memory (ROM), dynamic random access memory (DRAM), synchronous dynamic random access memory (SDRAM), phase change random access memory (PCRAM), and FLASH memory, among others. Memory cells can be arranged into arrays, with the arrays being used in memory devices.

Memory devices are utilized as volatile and nonvolatile data storage for a wide range of electronic applications. FLASH memory, which is just one type of memory, typically uses a one-transistor memory cell that allows for high memory densities, high reliability, and low power consumption.

One or more memory devices, including FLASH devices, can be combined together to form a memory drive (e.g., solid state drive, jump drive, FLASH stick, etc.). A memory device (e.g., data storage device) uses nonvolatile memory to store persistent data. As used herein, a memory drive intends one or more non-volatile memory devices that do not rely on rotating, magnetic, or optical media memory technologies. Although memory drives are sometimes referred to as solid state drives, they may include memory based on materials that are not always in a solid state or phase (e.g., PCRAM).

A memory drive often emulates a hard disk drive (but does not necessarily have to), and can be used to replace hard disk drives as the main storage device for a computer, as the memory drive can have large storage capacities, including a number of gigabytes. Multiple memory devices and/or memory drives can be coupled together by a controller through a number of channels. Memory drives can have superior performance when compared to magnetic disk drives due to their lack of moving parts, which eliminates seek time, latency, and other electro-mechanical delays associated with magnetic disk drives.

Memory devices and/or memory drives can include a controller implementing wear leveling techniques. These techniques can include rotating the cells in the memory device to which data is written. Wear leveling can also include garbage collection that entails rearranging data on the memory device to account for the dynamic or static nature of the data. Garbage collection included in the wear leveling techniques can be helpful in managing the wear rate of the individual cells of a memory array, for example. Some wear leveling techniques can limit the amount of data that is written on a memory drive, and can impact the rate of writing data and the time period over which data is written on the memory device, which can be a factor affecting the performance of the memory device.

In dynamic wear leveling, a block (i.e., block of memory cells, hereinafter “block”) in a memory array with a large amount of invalid pages can be reclaimed. A block can be reclaimed by moving valid data from an originating block (e.g., at a first location), to a destination block (e.g., at another location), and optionally erasing data from the originating block. Valid data can be data that is desired and should be preserved in memory cells, while invalid data can be data that no longer is desired and can be erased. A threshold for the number of total invalid memory locations (e.g., pages) in a block can be set to determine if a block will be reclaimed. Particular blocks can be reclaimed by scanning a block table for blocks that have a number of invalid memory locations above the threshold. A block table can have information detailing the type, location, and status, among other things, for the data in the memory cells.

In static wear leveling, a block storing static data, and having a corresponding smaller program/erase cycle count (e.g., program count, erase count, program/erase cycle count, cycle count), can be moved to (e.g., exchanged with) blocks that have larger cycle counts, so that the blocks with smaller cycle counts can be further utilized for additional program and erase operations. Blocks that have large cycle counts can be used to store static data, thereby mitigating increases in the cycle count for that block.

### BRIEF DESCRIPTION OF THE DRAWINGS

FIG. 1 is a functional diagram of a computing system in accordance with one or more embodiments of the present disclosure.

FIG. 2 is a functional diagram of a memory array in accordance with one or more embodiments of the present disclosure.

FIG. 3A illustrates a prior art memory table for storing cycle count information.

FIG. 3B illustrates a prior art memory table for storing cycle count information.

FIG. 3C illustrates a prior art memory table for storing cycle count information.

FIG. 4A is a functional diagram illustrating a method for populating a sample subset of memory locations in accordance with one or more embodiments of the present disclosure.

FIG. 4B is a functional diagram illustrating another method for populating a sample subset of memory locations in accordance with one or more embodiments of the present disclosure.

FIG. 4C is a functional diagram illustrating a further method for populating a sample subset of memory locations in accordance with one or more embodiments of the present disclosure.

FIGS. 5A-5C are charts illustrating search effectiveness, according to one or more embodiments of the present disclosure.

FIG. 6 is a functional diagram illustrating a method for wear leveling a memory in accordance with one or more embodiments of the present disclosure.

### DETAILED DESCRIPTION

The present disclosure includes methods, memory controllers and devices for wear leveling a memory. One method embodiment includes selecting, in at least a substantially random manner, a number of memory locations as at least a portion of a sample subset, the sample subset including fewer than all memory locations of the memory. A memory location having a particular wear level characteristic is identified from among the sample subset of memory locations, and data is written to the memory location identified from among the sample subset.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

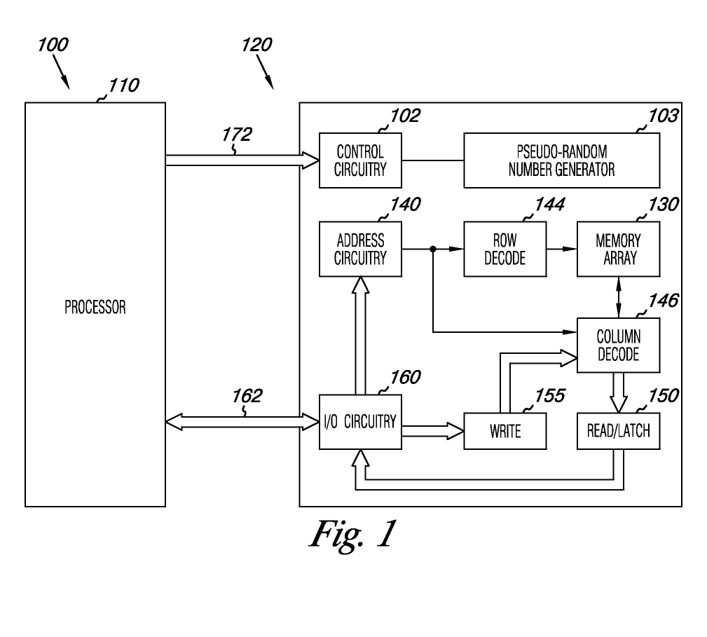

FIG. 1 illustrates a block diagram of a computing system in accordance with one or more embodiments of the present disclosure. Computing system 100 has at least one memory device 120 operated in accordance with one or more embodiments of the present disclosure. For ease of illustration, a single memory device 120 is shown in FIG. 1; however, one skilled in the art will appreciate that the concepts, methods and apparatus discussed with respect to memory device 120, may be applied to other computing system configurations that can include multiple memory devices, a memory drive, or other memory system, in place of memory device 120. As used herein, therefore, a “memory device” can mean a single memory device, multiple memory devices, a memory drive, or other memory system.

Computing system 100 includes a processor 110 coupled to a non-volatile memory device 120 that includes a memory array 130 of non-volatile cells. The computing system 100 can include separate integrated circuits or both the processor 110 and the memory device 120 can be on the same integrated circuit. The processor 110 can be a microprocessor or some other type of controlling circuitry such as an application-specific integrated circuit (ASIC).

The memory device 120 includes an array of non-volatile memory cells 130, which can be floating gate FLASH memory cells with a NAND architecture, for example. The control gates of memory cells are coupled with a select line, while the drain regions of the memory cells are coupled to sense lines. The source regions of the memory cells are coupled to source lines. As will be appreciated by those of ordinary skill in the art, the manner of connection of the memory cells to the sense lines and source lines depends on whether the array is a NAND architecture, a NOR architecture, and AND architecture, or some other memory array architecture.

The computing system embodiment illustrated in FIG. 1 includes address circuitry 140 to latch address signals provided over I/O connections 162 through I/O circuitry 160. Address signals are received and decoded by a row decoder 144 and a column decoder 146 to access the memory array 130. It will be appreciated by those skilled in the art that the number of address input connections depends on the density and architecture of the memory array 130 and that the number of addresses increases with both increased numbers of memory cells, blocks, and arrays.

The memory device 120 senses data in the memory array 130 by sensing voltage and/or current changes in the memory array columns using sense/buffer circuitry that in this embodiment can be read/latch circuitry 150. The read/latch circuitry 150 can read and latch a page, e.g., a row or a portion of a row, of data from the memory array 130. I/O circuitry 160 is included for bi-directional data communication over the I/O connections 162 with the processor 110. Write circuitry 155 is included to write data to the memory array 130.

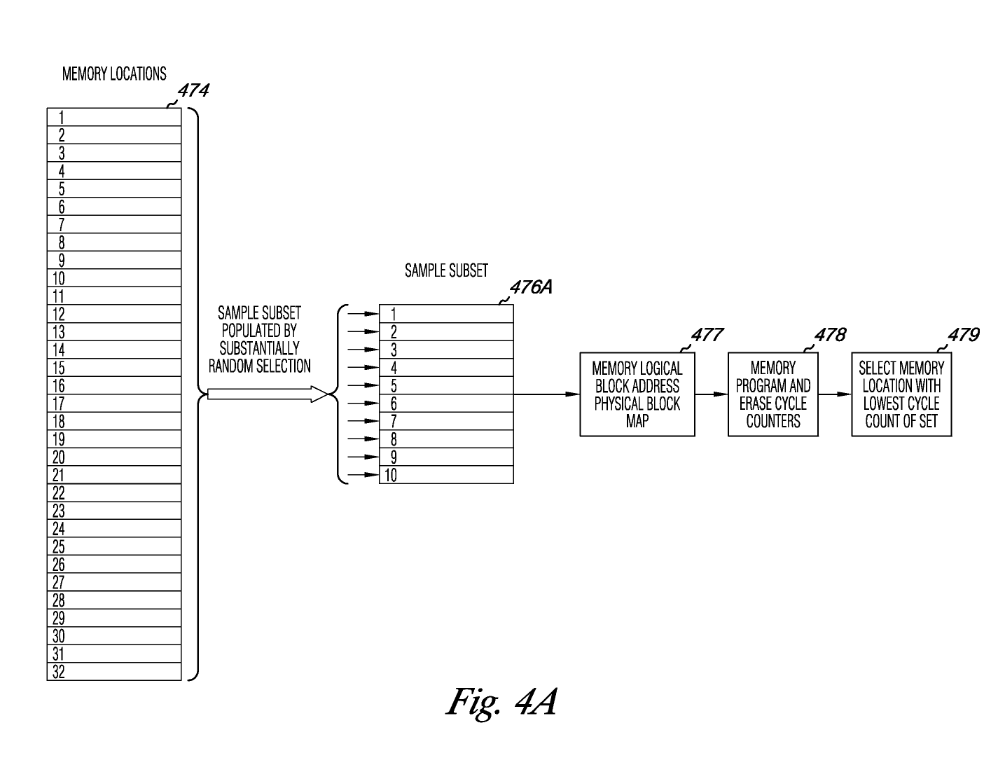

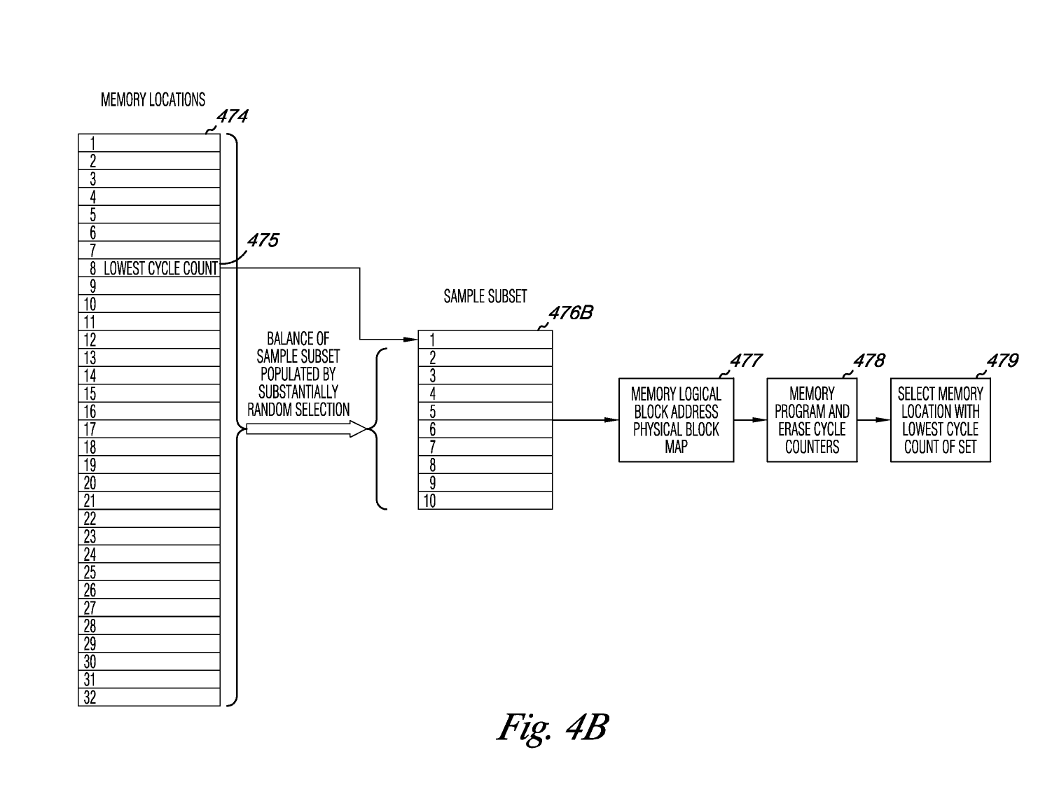

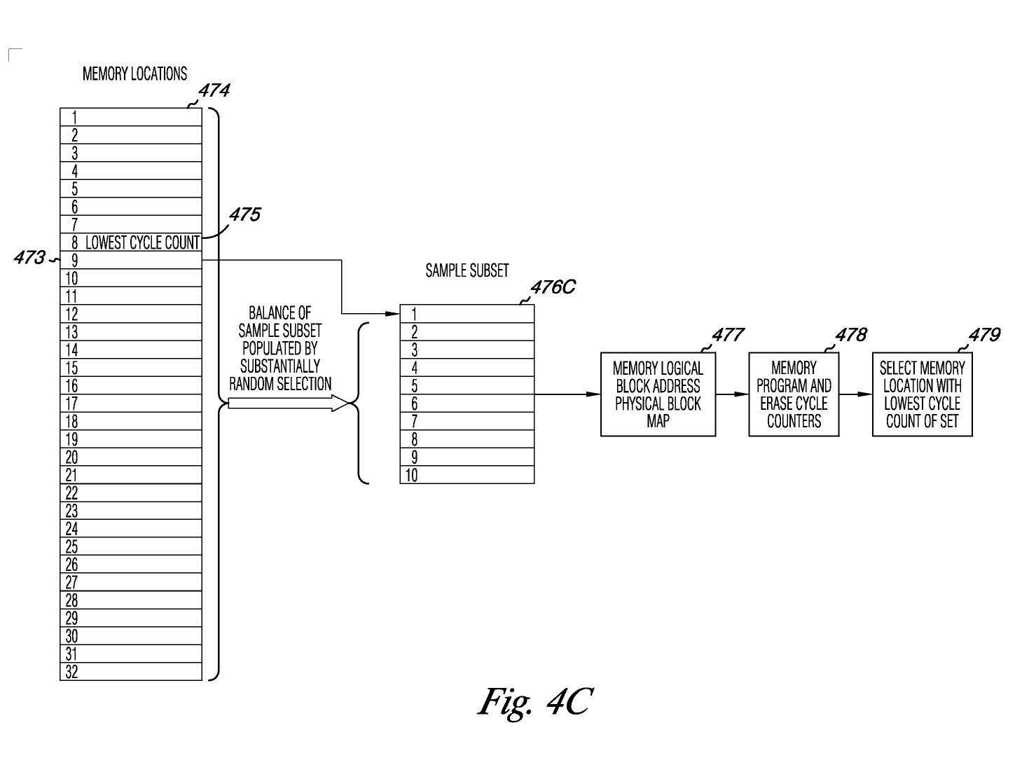

Memory device 120 includes control circuitry 102 communicatively coupled to a pseudo-random number generator 103. Control circuitry 102 decodes signals provided by control connections 172 from the processor 110. These signals can include chip signals, write enable signals, and address latch signals that are used to control the operations on the memory array 130, including data sensing, data write, and data erase operations. The control circuitry 102 can issue commands and/or send signals to selectively reset particular registers and/or sections of registers according to one or more embodiments of the present disclosure. In one or more embodiments, the control circuitry 102 is responsible for executing instructions from the processor 110 to perform the operations according to embodiments of the present disclosure. The control circuitry 102 can be a state machine, a sequencer, or some other type of controller. It will be appreciated by those skilled in the art that additional circuitry and control signals can be provided, and that the detail of memory device 120 illustrated in FIG. 4 has been reduced to facilitate ease of illustration.

Embodiments of the present disclosure can include a number of memory arrays. For instance, in one or more embodiments, the memory drive can include 16 memory arrays. Embodiments are not limited to a particular number of memory arrays. The memory arrays can be various types of volatile and/or non-volatile memory arrays (e.g., FLASH or DRAM arrays, among others). The memory arrays in embodiments of the present disclosure can include a number of channels with a number of memory arrays coupled to each channel. In various embodiments, the memory arrays can be coupled to the controller 102 with 8 channels and 4 memory arrays on each channel. In various embodiments, memory arrays can be partitioned into blocks that consist of 64 or 128 pages, for example, and each page can include 4096 bytes, for example. Embodiments of the present disclosure are not limited to a particular page and/or block size.

In one or more embodiments, the memory drive can implement wear leveling to control the wear rate on the memory arrays (e.g. 130). As one of ordinary skill in the art will appreciate, wear leveling can increase the life of a memory array since a memory array can experience failure after a number of program and/or erase cycles.

In various embodiments, wear leveling can include dynamic wear leveling to minimize the amount of valid blocks moved to reclaim a block. Dynamic wear leveling can include a technique called garbage collection in which blocks with a number of invalid pages (i.e., pages with data that has been re-written to a different page and/or is no longer needed on the invalid pages) are reclaimed by erasing the block. Static wear leveling includes writing static data to blocks that have high erase counts to prolong the life of the block.

In some embodiments, a number of blocks can be designated as spare blocks to reduce the amount of write amplification associated with writing data in the memory array. A spare block can be a block in a memory array that can be designated as a block where data can not be written. Write amplification is a process that occurs when writing data to memory arrays. When randomly writing data in a memory array, the memory array scans for free space in the array. Free space in a memory array can be individual cells, pages, and/or blocks of memory cells that are not programmed. If there is enough free space to write the data, then the data is written to the free space in the memory array. If there is not enough free space in one location, the data in the memory array is rearranged by moving the data that is already present in the memory array to a new location, and erasing the data from the old location, leaving free space for the new data that is to be written in the memory array. The rearranging of old data in the memory array is called write amplification because the amount of writing the memory arrays has to do in order to write new data is amplified based upon the amount of free space in the memory array and the size of the new data that is to be written on the memory array. Write amplification can be reduced by increasing the amount of space on a memory array that is designated as free space (i.e., where static data will not be written), thus allowing for less amplification of the amount of data that has to be written because less data will have to be rearranged.

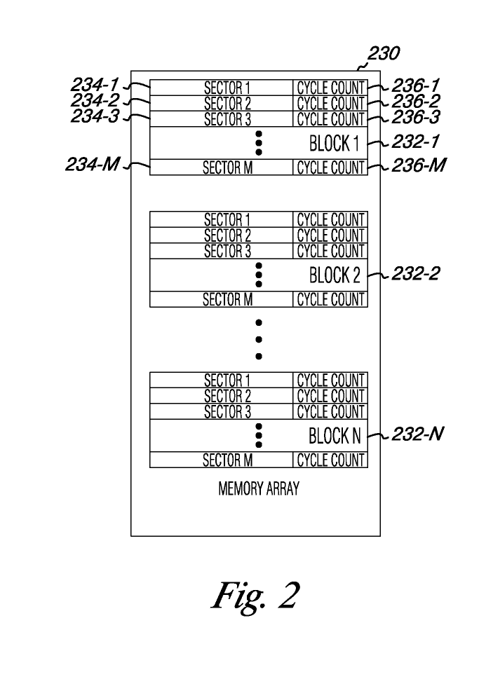

FIG. 2 illustrates a block diagram of a memory array in accordance with one or more embodiments of the present disclosure. Memory array 230 can include a number of blocks (e.g., 232-1, 232-2, . . . , 232-N). As used herein, the designators “N” and “M,” particularly with respect to reference numerals in the drawings, indicate that a number of the particular feature so designated can be included with one or more embodiments of the present disclosure. As will be appreciated, elements shown in the various embodiments herein can be added, exchanged, or eliminated so as to provide a number of additional embodiments of the present disclosure. In addition, as will be appreciated, the proportion and the relative scale of the elements provided in the figures are intended to illustrate the embodiments of the present disclosure, and should not be taken in a limiting sense.

For FLASH memory, a block (e.g., 232-1, 232-2, . . . , 232-N) often refers to the minimum number of memory cells that can be erased as a group, and can also be referred to herein as an “erase block.” Each block can include a number of sectors. Each sector may have a portion used for data storage (e.g., 234-1, 234-2, . . . , 234-M) and a portion used for storage of overhead information (e.g., 236-1, 236-2, . . . , 236-M) such as program/erase cycle count (e.g., hot count). While FIG. 2 illustrates a cycle count being associated with each respective sector, embodiments of the present disclosure are not so limited. For example, a memory array may be configured such that a cycle count is stored in, and associated with, each respective block. Overhead data, such as the cycle count for a particular sector, can be stored in the particular sector, or stored or stored in dedicated blocks separate from the blocks used to store user data.

FLASH memory cells can have a finite life span, often measured in program and erase cycle count. Therefore, FLASH memories may implement a system of wear leveling to keep repeated user writes to particular logical addresses from causing disproportionate program and erase cycle wear to the corresponding physical erase blocks. For example, wear leveling may select an alternate FLASH physical block (usually with its own associated user logical block address) to replace the block experiencing disproportionately wear (e.g., relatively large cycle counts).

Various previous approaches to wear leveling include surveying all available blocks of the memory to identify an erase block having the lowest program/erase cycle count. Thereafter, data stored in a block with a high level of wear (e.g., high cycle count) may be relocated to the erase block having the lowest program/erase cycle count. For example, data stored in the block with the high level of wear (e.g., high cycle count) may be exchanged with data stored in the block having the lowest program/erase cycle count.

In other various previous approaches, the program/erase cycle count for all physical erase blocks used by the memory was summarized in a table to reduce cycle count search time (e.g., in a table stored in RAM that would need to be initialized after power is applied from data stored in non-volatile memory, for instance the FLASH itself). Often, the program/erase cycle count is stored in the memory itself so that the respective cycle counts are maintained even when power is lost. Searching each erase block to find the block with the lowest cycle count at the time of selection for a wear leveling data transfer is costly in terms of processing resources and time.

As an alternative to searching each erase block to find the block with the lowest cycle count at the time of selection for a wear leveling data transfer, some wear leveling previous approaches maintained some form of sorted list (e.g., table) of cycle counts in order to reduce the processing overhead at the time of lowest block cycle count selection. This previous approach includes storing an additional table that can be rather large in size (e.g., kilobytes of memory cells are used to provide greater than 1000 16-bit counters), and includes table update processing overhead. The entire table needs to be stored in memory (e.g., nonvolatile memory or RAM) in order to maintain data during loss of power, thereby reducing the amount of memory available for use by the user.

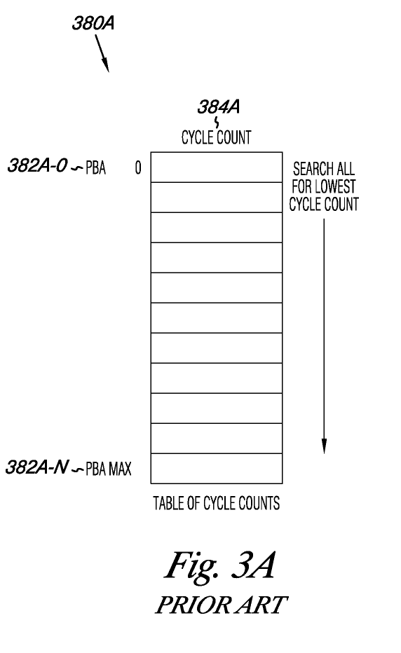

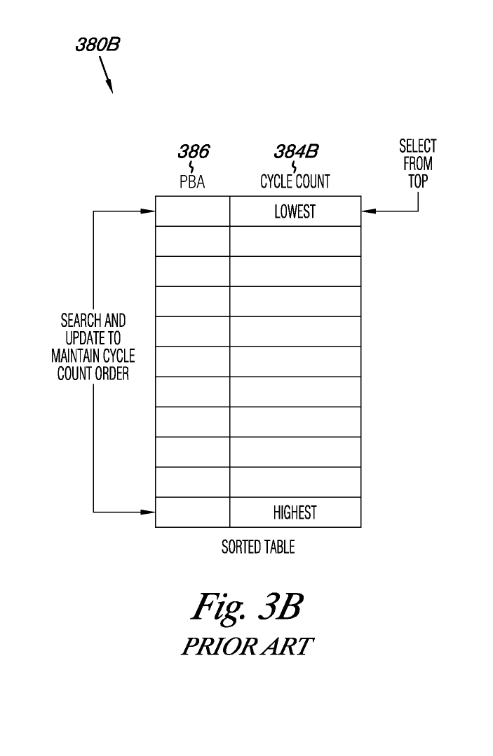

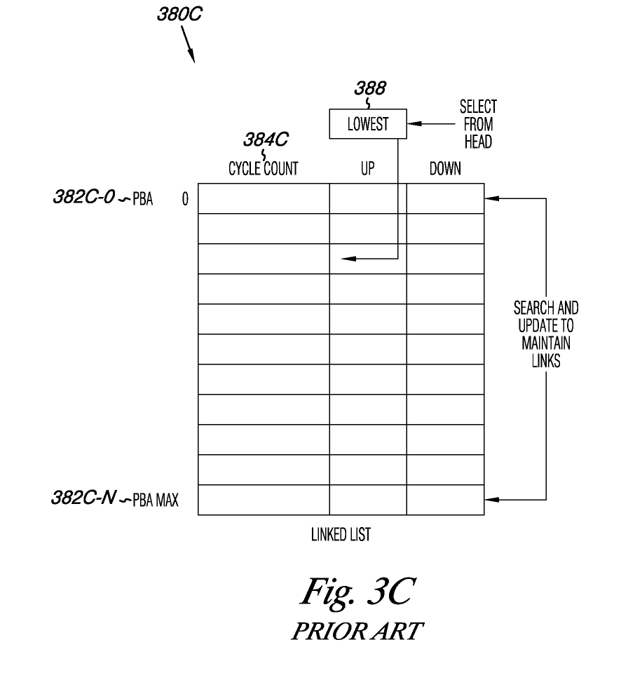

Selection and update operations still require a table search rather than a search of the entire memory. However, as the reader will appreciate from the specific descriptions that follow, some table implementations may include searching the entire length of the table. Table update processing overhead could be time shifted to occur when wear leveling selection of a block with the lowest cycle count was not pending. Various table organizations have been used in previous approaches, some of which are described with reference to FIGS. 3A-3C. Generally, efforts to reduce selection and update processing time and overhead during the actual selection of a block having the lowest cycle count with a wear leveling data transfer pending can include the use of even more memory table resources.

FIG. 3A illustrates a prior art memory table for storing cycle count information. Memory table 380A is arranged as a table of cycle counts, and is organized to have a cycle count entry 384A corresponding to each physical block address (e.g., 382A-0, . . . , 382A-N) of the memory. During wear leveling operations of the memory, the cycle count entries of the table are searched to find the lowest cycle count, and the corresponding physical block address is returned. The reader will appreciate that the entire length of the table must be searched in determining the lowest cycle count among all entries.

FIG. 3B illustrates a prior art memory table for storing cycle count information. Memory table 380B is arranged as a sorted table, and is organized such that a cycle count entry 384B corresponds to each physical block address 386 of the memory. However, the table 384B is sorted on the cycle count entries, from lowest to highest cycle count, with the corresponding physical block address entries being thereby arranged. The reader will appreciate that the physical block entries are therefore not in their numerical order in the table, but rather sorted in the table, top to bottom, from lowest to highest cycle count. During wear leveling operations of the memory, selection from the top of the table 384B provides the lowest cycle count and corresponding physical block address. Therefore, the time and processing overhead to search the entire table is eliminated at the time of selection. However, ongoing table organization is necessary in the background to continually update the table order as a result of each memory operation.

FIG. 3C illustrates a prior art memory table for storing cycle count information. Memory table 380C is arranged as a linked list, and is organized such that a cycle count entry 384C corresponds to each physical block address (e.g., 382C-0, . . . , 382C-N) of the memory. Like the table illustrated in FIG. 3A, the table 384C is arranged by the physical block addresses (e.g., 382C-0, . . . , 382C-N); however, the corresponding cycle count entries are pre-searched to locate the lowest cycle count, and loaded into a head register 388. During wear leveling operations of the memory, selection from the head register 388 provides the lowest cycle count and/or corresponding physical block address. Thus the time and processing overhead to search the entire table is eliminated at the time of selection. However, ongoing table organization is necessary in the background to continually search and update the table to maintain links, and contents of the head register 388 as a result of each memory operation.

Embodiments of the present disclosure provide benefits over previous approaches, such as a reduction in processing overhead and/or cycle count memory table requirements. One or more embodiments of the present disclosure include selecting a logical block address, and associated physical FLASH erase block address, for static block relocation in a FLASH memory wear leveling. However, embodiments of the present disclosure are not so limited, and may be applied to other memory technologies, and dynamic wear leveling operations in response to program/erase cycle degradation. Methods used to identify a particular block in need of wear leveling is beyond the scope of this disclosure, but will be understood by those of ordinary skill in the art.

According to one or more embodiments of the present disclosure, a destination memory location (e.g., erase block) for wear leveling operations is selected as the memory location with the lowest program/erase cycle count within a sample subset of memory locations, rather than by a process of identifying the memory location with the lowest program/erase cycle count from among all available memory locations. As illustrated in FIG. 2, program/erase cycle counts can be maintained for all physical erase blocks with the memory (e.g., FLASH memory). However, rather than search the cycle count for all memory locations, or maintain a table summarizing cycle counts for each memory location, a sample subset of memory locations is taken, and the sample subset is searched to find the memory location with the lowest program/erase cycle count. The memory location of the subset determined to have the lowestmost cycle count is used as the destination memory location for a wear leveling data transfer operation.

The reader will appreciate that a particular destination memory location of the subset may not be the memory location with the lowest program/erase cycle count of all memory locations, and may not even have a program/erase cycle count that is lower than the originating memory location (in which case, no transfer is performed). However, applied over many wear leveling operations, the method of the present disclosure can provide comparable wear leveling performance with reduced processing, time, and memory usage overhead requirements, as compared to previous approaches.

FIG. 4A is a functional block diagram illustrating a method for populating a sample subset of memory locations in accordance with one or more embodiments of the present disclosure. A memory 474 can have a number of memory locations. Memory 474 can be a memory array (e.g., 130 in FIG. 1), and can be configured as shown for memory array 230 in FIG. 2. While memory 474 is shown having thirty-two (32) memory locations (e.g., blocks), the reader will appreciate that embodiments of the present disclosure are not limited to a particular number of memory locations, and can be configured with more or fewer memory locations.

According to one or more embodiments of the present disclosure, prior to, or during, a wear leveling operation, a sample subset 476A of memory locations is selected from memory locations of the memory 474. As indicated in FIG. 4A, the sample subset can be populated by memory locations selected using at least a substantially random selection process. As one having ordinary skill in the art will appreciate, the more random the selection process, the lower the correlation between selections, and between selection sets (e.g., sample subsets). However, acceptable results can be achieved by using a substantially random selection process (e.g., using a pseudo-random number generator rather than a random number generator). Substantially random number generation can be achieved by a pseudo-random number generator, or other equivalent circuitry or process. Embodiments of the present invention are not limited to those processes and/or apparatus that provide particular statistical correlations, as the wear leveling results achieved are related to the efforts taken towards implementing as random a selection process as practical for the particular application and desired performance.

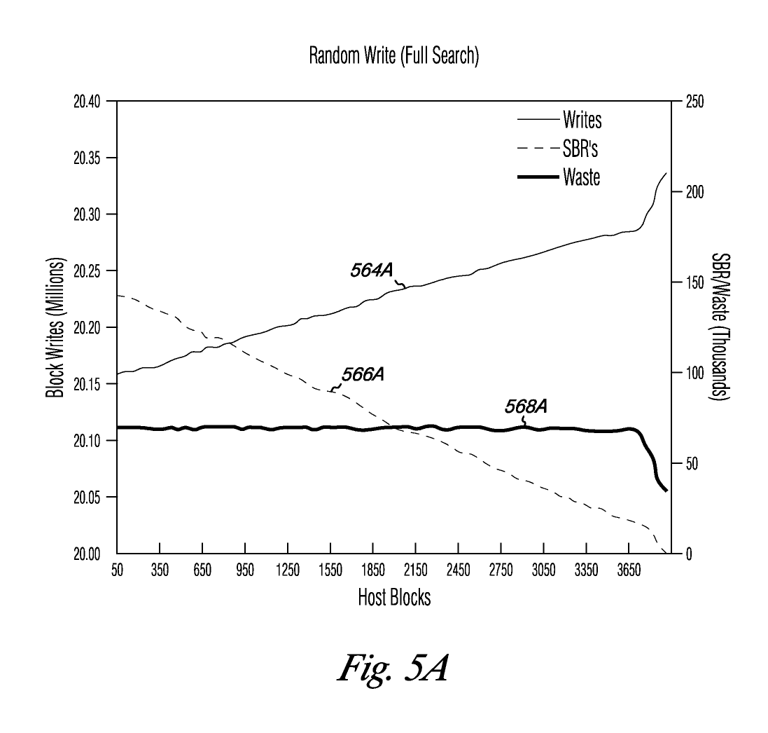

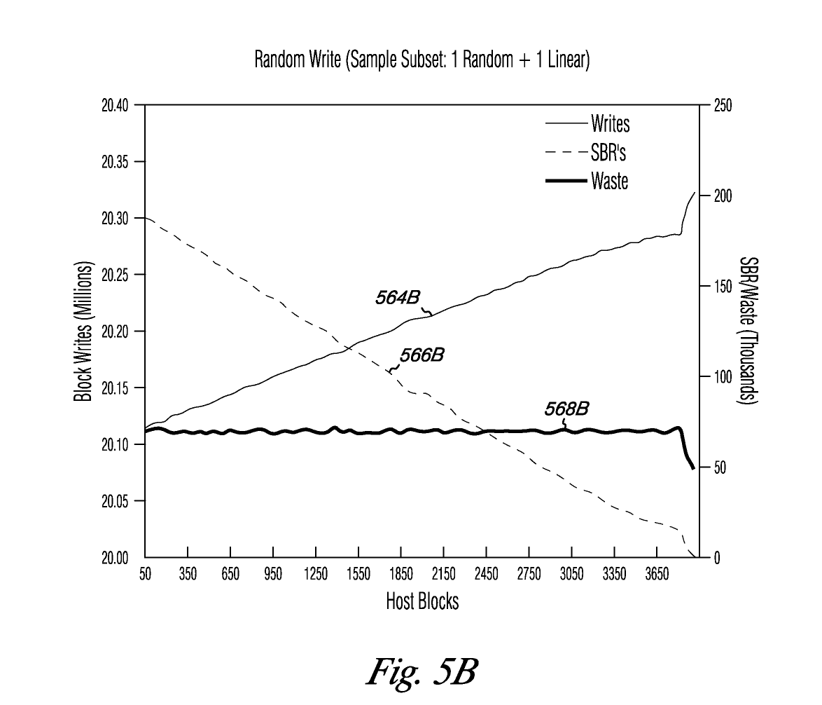

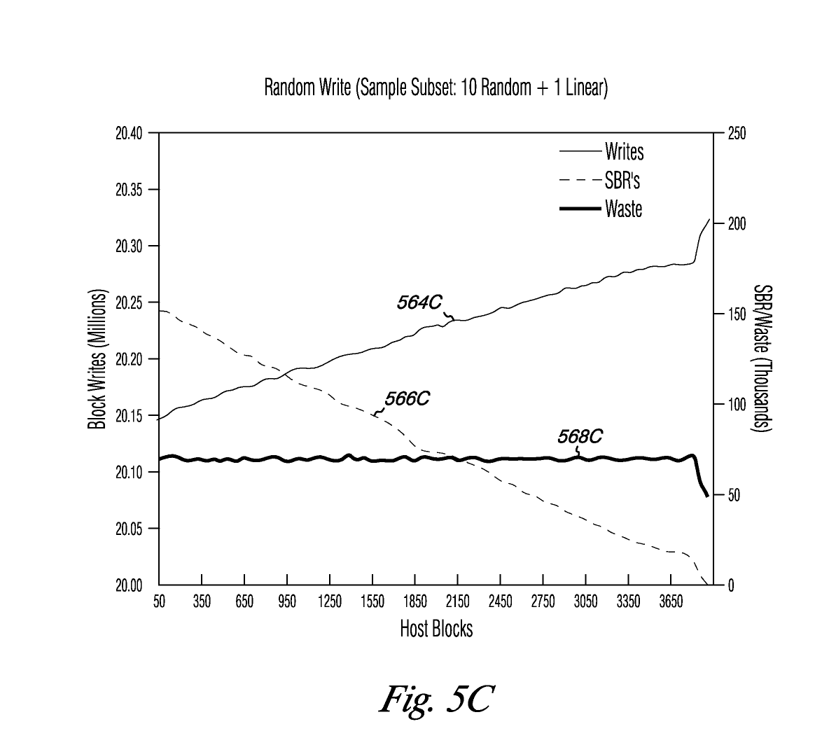

One having ordinary skill in the art will appreciate that the larger the sample subset, the greater the processing time and overhead needed to create and process the sample subset. However, a relatively larger sample subset can also produce statistically better results than a sample subset comprised of a smaller number of memory locations. Thus, there is a trade-off associated with sample subset size between speed and wear leveling effectiveness. However, experiments have unexpectedly shown that similar wear leveling effectiveness can be achieved using relatively small sample sizes (e.g., a small percentage of possible memory locations, a sample subset using 1% or less of the possible memory locations, such as 10 of 4000 memory locations, a sample subset of 0.25% of the possible memory locations). These unexpected results are further discussed with respect to FIGS. 5A-5C below. Embodiments of the present disclosure are not limited to a particular sample subset size, and may be implemented using any size sample subset appropriate to the desired constraints between processing overhead and speed, and wear leveling effectiveness.

The number of pseudo-random memory locations comprising the sample subset may be any value greater or equal to one (1), and less than or equal to all memory locations. Using more than one (1) memory location can include additional memory controller processing overhead to obtain and search cycle counts; however, wear leveling performance can be improved by statistically providing a lower average cycle count selection from a more populous sample subset. Results very similar to selection of a destination block having the lowest absolute cycle count have been obtained experimentally using as few as 10 of 4,000 (e.g., 0.25%) memory locations in each sample subset.

A substantially random selection process can be achieved using a pseudo-random number generator (e.g., algorithm implemented in firmware located on the memory controller). Embodiments of the present disclosure are not limited to use of a pseudo-random number generator implemented in firmware. A pseudo-random number generator, or other means for generating substantially random memory location selections, may alternatively be implemented in software and/or hardware. A pseudo-random logical block address may be generated by the pseudo-random number generator by limiting the output thereof to the logical block address range. The pseudo-random number generator is implemented to have a low correlation between samples to allow maximum independence of the sample within, and between, sample subsets.

According to one or more embodiments of the present disclosure, the pseudo-random number generator can be seeded using a value stored in the memory (e.g., at a particular location) responsive to an initiating event, such as power-up of the memory. By seeding the pseudo-random number generator using a value stored in the memory at a particular location, different values may be present at the particular memory location at each power-up, thereby providing different seeds to the pseudo-random number generator. However, embodiments of the present disclosure are not so limited, and reasonable results can be obtained using other seeds, or even if the particular memory location value does not change from one power-up to another.

Once a substantially random sample subset of the memory 474 is obtained, and a number of memory locations (e.g., logical blocks, logical block identifiers such as logical block addresses) are included in the sample subset 476A, correspondence of each logical block address to an associated physical block address can be identified from a memory system logical block address to physical block address map, as shown in FIG. 4A at 477. Having determined the physical block addresses corresponding to the logical block address comprising the sample subset 476A, the program/erase cycle counts for the subset of physical block addresses can be obtained from the memory, as indicated at 478, and the memory location (e.g., block address) having the lowest cycle count of the subset can be identified, as indicated at 479. The memory location (e.g., block address) having the lowest cycle count of the subset can then be used as a destination block address for a wear leveling data transfer operation, as will be understood by one of ordinary skill in the art.

According to various embodiments, after program/erase cycle counts for the subset of physical block addresses is obtained from the memory, as indicated at 478, one or more memory locations (e.g., block address) having a cycle count below a particular threshold can be identified from among the subset. The one or more memory locations (e.g., block addresses) so identified can then be used as a destination block address for a wear leveling data transfer operations.

The wear leveling data transfer operation can involve writing data, which may be included in moving data, which in turn may be included in exchanging data. For example, dynamic wear leveling involves data that may be received from a host, and using the wear leveling methods described herein to identify a memory location having a relatively low cycle count (e.g., so as to make use of lesser-used memory locations). Therefore, the wear leveling data transfer can include writing the data received from the host to the destination block identified from a sample subset. For static wear leveling, data can be moved from an originating block to the destination block (e.g., read from the originating block and written to the destination block). According to various embodiments of the present disclosure, data from an originating block (e.g., a block having been identified as having a large cycle count) can be exchanged with data in the destination block. That is data initially in a first (e.g., originating) block is read from the first block and written to a second (e.g., destination) block, and data initially in the second block is read from the second block and written to the first block.

FIG. 4B is a functional block diagram illustrating another method for populating a sample subset of memory locations in accordance with one or more embodiments of the present disclosure. The embodiment of the present disclosure corresponding to FIG. 4B is similar to that described above with respect to FIG. 4A. FIG. 4B illustrates population of a first sample subset responsive to initiating event such as power-up of the memory 474. At the initiating event (e.g., power-up) at least one memory location will have a lowest cycle count, indicated in FIG. 4B at 475.

According to one or more embodiments of the present disclosure, prior to, or during, a wear leveling operation after an initiating event, a sample subset 476B of memory locations can be selected from memory locations of the memory 474. As indicated in FIG. 4B, this first sample subset after the initiating event can be populated by memory locations selected by searching the memory 474 to identify the memory location (e.g., logical block address) having the absolute lowest cycle count 475 (e.g., lowestmost cycle count with respect to all memory locations). Sample subset 476B is selected by including the memory location (e.g., logical block address) having the absolute lowest cycle count 475 in sample subset 476B, and selecting the balance of the memory locations to populate the sample subset 476B by the substantially random process described above with respect to FIG. 4A. The sample subset 476B is processed thereafter, just as sample subset 476A is processed.

One having ordinary skill in the art will recognize that for the first sample subset 476B after the initiating event, since the sample subset 476B includes the memory location with absolute lowest cycle count 475 of the memory 474, it will be chosen in determining the memory location having the lowest cycle count from the memory locations of the sample subset. In this manner, the first wear leveling operation after an initiating event uses, as a destination block address, the memory location having the absolute lowest cycle count.

The initiating event is not limited to being a power-up event (e.g., power on, recovery from a sleep state, etc.), and may include, in some embodiments, additional or alternative events, such as memory idle periods (which can afford the time and processing resources for memory to be searched when not being otherwise utilized, for example). Other initiating events are contemplated, including but not limited to, expiration of a time duration, occurrence of a particular cycle count, initiation of a certain wear leveling routine, etc.

Embodiments of the present disclosure are not limited to including a memory location having the absolute lowest cycle count as an initial memory location in the first sample subset selected from an ordered selection process (as is described further with respect to FIG. 4C below). The initial memory location selected by the ordered selection process may be a least significant memory location of the memory, a most significant memory location of the memory, a last memory location accessed before an initiating event, or other defined memory location. One having ordinary skill in the art will appreciate that the ordered selection process can then proceed from the initial memory location, for example, including one or more memory locations selected by a round robin process until all memory locations are included in one of subsequent sample subsets.

FIG. 4C is a functional block diagram illustrating a further method for populating a sample subset of memory locations in accordance with one or more embodiments of the present disclosure. The embodiment of the present disclosure corresponding to FIG. 4C is similar to that described above with respect to FIG. 4B. FIG. 4C illustrates population of a sample subset subsequent to the first sample subset. At the initiating event (e.g., power-up) at least one memory location will have a absolute lowest cycle count, as described above and indicated in FIG. 4C at 475.

According to one or more embodiments of the present disclosure, prior to or during a wear leveling operation, but subsequent to selection of the first sample subset 476B after an initiating event, a sample subset 476C of memory locations can be selected from memory locations of the memory 474. As indicated in FIG. 4C, this subsequent sample subset can be populated by first selecting a memory location 473 located at an offset from the memory location (e.g., logical block address) having the absolute lowest cycle count 475.

For example, in selecting the a second sample subset 476C, the offset can be one, such that a memory location adjacent the memory location (e.g., logical block address) having the lowest cycle count 475. According to one or more embodiments, the offset can increase (or decrease) linearly by one (or some other increment) when selecting each respective sample subset. The reader will appreciate that by changing the offset in the process of selecting each subsequent sample subset, a round-robin stepping through each memory location (e.g., an offset of one memory location) can be achieved, such that eventually, each memory location will be included in at least one sample subset. Incrementing the offset in a round robin manner, as used herein, can include decrementing the offset, and can include changing the offset to proceed to the least significant memory location in “incrementing” the offset positively from the most significant memory location (or changing the offset to proceed to the most significant memory location in “incrementing” the offset negatively from the least significant memory location).

Embodiments of the present disclosure are not limited to linearly incrementing the offset by one in selecting each new sample subset. Other routines that ensure that each memory location will eventually be included in at least one sample subset are contemplated. Neither are embodiments of the present disclosure limited to a round robin sequence, for example, a sequence where the offset increases until a most significant memory location is reached, and then decreases until a least significant memory location is reached, and then increases, etc. will also eventually step through each memory location being included in a sample subset.

Furthermore, while including a single memory location selected based on an offset with respect to a given location (e.g., a memory location having a lowest cycle count at an initiating event) has been described for simplicity, other quantities of non-randomly selected memory locations are contemplated. For example, other quantities are contemplated such as two, or three, or ten memory locations can be initially included in a given sample subset, with a balance of memory locations in a given subset then being substantially randomly selected to fill-out the sample subset are contemplated.

Embodiments of the present disclosure are not limited to populating the first sample subset with the memory location having the lowest cycle count, and instead may begin with another memory location. For example, the first sample subset may begin with the least significant memory location and increment the memory location from there for subsequent sample subsets, or may begin with the most significant memory location and decrement the memory location from there for subsequent sample subsets, or may begin by incrementing from the last memory location before the initiating event (e.g., from where the round robin process previously left off). However, it has been observed experimentally that a memory location contribution to the sample subset that initially includes the memory location with the absolute lowest cycle count after power-up, and also potentially cycles through including each of all possible memory locations, one at a time, in a respective sample subset in the minimum number of sample subsets, provides good results compared to always selecting the memory location with the lowest absolute cycle count as the destination block for wear leveling operations.

While this disclosure has described including a memory location offset from the memory location having the lowest cycle count at an initiating event, the same outcome can be achieved using logic to process the offset memory location separately and only include the substantially randomly selected memory locations in the sample subset, and then select between the outcomes of the sample subset OR the offset memory location to determine the destination memory location.

Thus far, embodiments of the present disclosure have utilized program/erase cycle count as the measure for determining a destination block address for wear leveling operations. This criteria has applicability at least to FLASH memory, and other technologies that are subject to such cycling degradation. However, embodiments of the present disclosure are not limited to cycle count, and may include another wear level characteristic, in addition to or in lieu of, cycle count. For example, wear leveling may be based upon measure of some other characteristic of the memory, and embodiments of the present disclosure may be implemented based on such characteristic instead of program/erase cycle count.

One or more embodiments of the present disclosure may be implemented determining logical block addresses from a sample subset, and converting via a map to physical block address, or may instead use physical block addresses directly in the sample subset, thereby eliminating the step of converting from logical to physical block addressing.

FIGS. 5A-5C are charts illustrate search effectiveness, according to one or more methods of the present disclosure. Particular search methodologies were simulated, and experimental data showed unexpected results. Each graph presents data associated with repeatedly writing varying amounts of erase blocks in a “random write” addressing pattern. Similar results were obtained for data associated with “sequential write” and triangle write” addressing patterns, which are discussed further below.

In each of the simulations illustrated in FIGS. 5A-5C, the memory logical capacity is 3,818 blocks, and the physical capacity is 4,074 blocks (i.e., 4,096 blocks less 20 defect and 2 system blocks). The maximum block cycles used for the simulation model are 5,000 cycles. The total maximum cycles is 20,370,000 (i.e., 4,074 blocks×5,000 cycles).

FIG. 5A is a graph illustrating a method of static block selection involving fully searching all memory blocks for an absolute lowestmost erase count. The horizontal axis in each of FIGS. 5A-5C represent varying quantities of erase blocks being repeatedly written in a memory by a host (e.g., logical host blocks). Data line 564A represents random block writes, in millions, the data plotted according to the scale on the left vertical axis. Data line 566A represents SBRs, and is plotted according to the scale of SBR/waste, in thousands, on the right vertical axis. Data line 568A represents waste, and is also plotted according to the scale of SBR/waste, in thousands, on the right vertical axis.

FIG. 5B is a graph illustrating a method for static block selection involving searching a sample subset having one (1) member selected in a substantially random manner and one (1) member selected in a non-random manner (e.g., beginning with a memory block determined to have an absolute lowestmost erase count at power-up, and proceeding linearly in a round robin fashion through all memory blocks) in accordance with one or more embodiments of the present disclosure. The writes 564B, SBRs 566B and waste 568B data lines are plotted according to the scales of their respective vertical axes, as described above with respect to FIG. 5A.

FIG. 5C is a graph illustrating a method for static block selection involving searching a sample subset having ten (10) members selected in a substantially random manner and one (1) member selected in a non-random manner (e.g., beginning with a memory block determined to have an absolute lowestmost erase count at power-up, and proceeding linearly in a round robin fashion through all memory blocks) in accordance with one or more embodiments of the present disclosure. The writes 564C, SBRs 566C and waste 568C data lines are plotted according to the scales of their respective vertical axes, as described above with respect to FIG. 5A.

The results plotted in FIGS. 5B and 5C are compared with results plotted in FIG. 5A, as the full search method illustrated in FIG. 5A is the most thorough (but requires the most time and processing power to accomplish). Data line 564A begins on the left side of FIG. 5A at approximately 20.16 million writes when 50 host blocks are being repeatedly written in a memory according to a random addressing pattern. By searching a sample subset having only 2 members (one member selected in a substantially random manner and one member selected by a linear round-robin process), rather than filly searching all memory blocks, for an absolute lowestmost erase count, data line 564B begins on the left side of FIG. 5B at approximately 20.12 million writes when 50 host blocks are being repeatedly written in a memory according to a random addressing pattern. The time and processing power saved by the method of searching only two (2) memory blocks of the sample subset instead of fully searching all memory blocks, is significant, while performance is reasonably maintained.

Increasing the sample subset size to eleven (11) members (ten members selected in a substantially random manner and one member selected by a linear round-robin process), rather than fully searching all memory blocks, for an absolute lowestmost erase count, data line 564C begins on the left side of FIG. 5C at approximately 20.15 million writes when 50 host blocks are being repeatedly written in a memory according to a random addressing pattern. Unexpectedly, this performance is nearly identical to fully searching all memory blocks. However, significant time and processing power savings are realized by the method illustrated in FIG. 5C since only eleven (11) memory blocks of the sample subset are searched to determine a lowestmost erase count, rather than fully searching all memory blocks to find an absolute lowestmost erase count.

As the reader will appreciate, the efficiency of searching a sample subset is scalable, and does not require large sample sizes (relative to the entire population of memory blocks) to achieve reasonable results. As indicated above, the unexpected efficiencies obtained using a sample subset, including at least one member selected in a substantially random manner and at least one member selected by a non-random process designed to eventually include each memory block in a sample subset, were effectively independent of the addressing pattern used (e.g., “random write,” “sequential write,” “triangle write.” Similar results as those described above for 50 host blocks being repeatedly written in a memory according to a “random write” addressing pattern were obtained where “sequential write” or “triangle write” addressing patterns were utilized.

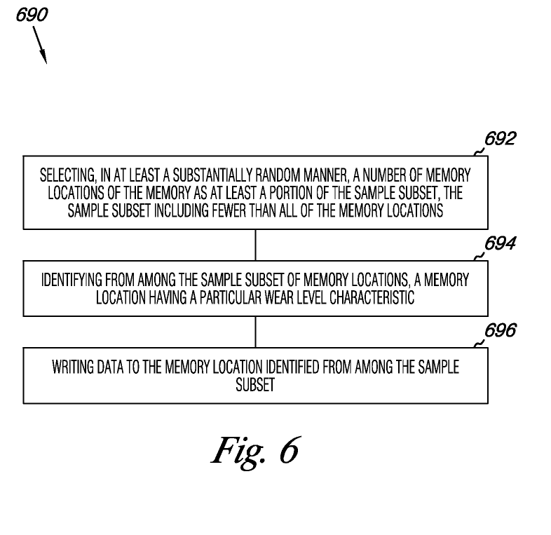

FIG. 6 is a functional block diagram illustrating a method for wear leveling a memory in accordance with one or more embodiments of the present disclosure. Method 690 includes selecting, in at least a substantially random manner (where an “at least a substantially random manner can include an entirely random manner), a number of memory locations as at least a portion of a sample subset, the sample subset including fewer than all memory locations at step 692. Step 694 provides a memory location having a particular wear level characteristic is identified from among the sample subset of memory locations, and at step 696 data from an originating memory location is moved to the memory location identified from among the sample subset.

According to one or more embodiments of the present disclosure, a memory device can include a memory having a number of memory locations, and control circuitry coupled to the memory. The control circuitry can be configured to determine, from among a representative sample of the memory locations, a destination memory location having a lowestmost cycle count from among the representative sample, and write data to the destination memory location. The control circuitry can also be configured to select at least a portion of the memory locations included in the representative sample in a pseudo-random (e.g., substantially random) manner, for example through the use of a pseudo-random number generator.

The control circuitry can also be configured to include in the representative sample a number of memory locations from an ordered selection process, in addition to the subset of memory location(s) selected by a substantially random process. According to one or more embodiments of the present disclosure, the control circuitry can be configured to include one, or more, memory locations selected by an ordered, e.g., round robin, selection process, the ordered process having an initial memory location. For example, an ordered process may be used to select subsequent memory locations from an initial memory location having an absolute lowestmost cycle count from among the number of memory locations at power-on. The memory location having the absolute lowestmost cycle count can be determined by initially searching all of the number of memory locations after power-on of the memory.

The control circuitry can be farther configured to include in subsequent representative samples, one or more memory locations selected from among the number of memory locations by a round robin process beginning with the memory location having an absolute lowestmost cycle count from among the number of memory locations at memory power-on of the memory. Other initial memory locations from which the ordered selection process progresses can include a least significant memory location, with the ordered selection process selecting a next significant memory location; a most significant memory location, with the ordered selection process selecting a next less significant memory location; a last memory location accessed before an initiating event occurs; or a last memory location selected by the ordered selection process before an initiating event occurs, among others.

Wear leveling can be used in processing data dynamically, or in static life cycle management of the memory. Thus, the control circuitry can be configured to identify, in response to a wear leveling analysis, a memory location that can benefit from wear leveling (e.g., an originating memory location having a relatively large cycle count). Data in the originating block can be written to (e.g., moved to, transferred to, exchanged with data in) a destination block.

Data being received on a communication path (e.g., from a host) does not initially reside in an originating block; however, it may be beneficial to store the received data at a destination memory location having a relatively low cycle count. Therefore, the control circuitry can be configured to determine, from among a representative sample of the memory locations, a destination memory location having a lowestmost cycle count of a sample subset including substantially randomly-selected members and/or members selected by an ordered selection process, and write the received data to the destination memory location identified from among the sample subset in response to receiving the data from a host.

According to various embodiments of the present disclosure, a memory device can include a number of FLASH memory arrays, with the control circuitry being coupled to the FLASH memory arrays. The control circuitry can be configured to substantially randomly (e.g., using a pseudo random number generator) select a sample subset of fewer than all logical blocks associated with the FLASH memory arrays, determine physical blocks corresponding to the logical blocks of the sample subset, and identify, from the determined physical blocks, a physical block having a lowestmost cycle count. Thereafter, the control circuitry can be configured to write data to the physical block identified to have the lowestmost cycle count. The data written to the physical block identified to have the lowestmost cycle count can be data from an originating physical block, or data received from a host.

The control circuitry can be configured to select, as a portion of the sample set, a logical block corresponding to a physical block having a lowestmost cycle count at an initiating event. For example, the initiating event can be power-up of the memory device (e.g., power-on, recovery from a sleep state or hibernation), or the initiating event can be an idle period of the memory device (e.g., when the memory has time available to search the memory locations to identify a memory location having an absolute lowestmost cycle count without delaying other memory read and/or write operations).

The control circuitry can be further configured to select, as a portion of the sample subset, a logical block corresponding to a physical block located at a non-zero offset from an initial physical block (e.g., having the lowestmost cycle count at an initiating event, a least significant physical block, a most significant physical block, a previously accessed physical block, etc.). The offset can be different for each respective selection of a sample subset. For example, the offset can change linearly by a fixed increment for each respective selection of a sample subset in a round robin manner through all physical blocks.

According to one or more embodiments of the present disclosure, a memory controller can include a pseudo-random number generator, and control circuitry in communication with the pseudo-random number generator. The control circuitry can be configured to select a number of logical blocks of a FLASH memory based on output of the pseudo-random number generator, determine physical blocks corresponding to the selected logical blocks, identify which of the determined physical blocks has a lowestmost cycle count, and write data to the physical block identified as having the lowestmost cycle count in response to a wear leveling operation. The selected number of logical blocks of a FLASH memory can include a logical block corresponding to a physical block having an absolute lowestmost cycle count of all available physical blocks of the FLASH memory, for example at a first selection of logical blocks after a power-up of the memory. For subsequent selection of logical blocks (e.g., where the logical block corresponding to a physical block having an absolute lowestmost cycle count is not included), the cycle count of the identified physical block having the lowestmost cycle count can be larger than the absolute lowestmost cycle count for all physical blocks.

The control circuitry can also be configured to select at least one physical block by an ordered (e.g., non-random) selection process beginning with an initial physical block (e.g., having the lowestmost cycle count at power-up of the FLASH memory). The non-random process can be a linear process selecting each physical block in order in a round-robin manner.

### Conclusion

The present disclosure includes methods, memory controllers and devices for wear leveling a memory. One method embodiment includes selecting, in at least a substantially random manner, a number of memory locations as at least a portion of a sample subset, the sample subset including fewer than all memory locations of the memory. A memory location having a particular wear level characteristic is identified from among the sample subset of memory locations, and data is written to the memory location identified from among the sample subset.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for wear leveling a memory, the method comprising:
selecting, in at least a substantially random manner, a number of memory locations of the memory as at least a portion of a sample subset, the sample subset including fewer than all of the memory locations of the memory;
identifying from among the sample subset of memory locations, a memory location having a particular wear level characteristic; and
writing data to the memory location identified from among the sample subset.

2. The method of claim 1, wherein the method includes identifying from among the sample subset of memory locations, a memory location having a cycle count below a particular threshold.

3. The method of claim 1, wherein the method includes identifying from among the sample subset of memory locations, a memory location having a lowestmost cycle count.

4. The method of claim 3, wherein the method includes selecting, as at least a portion of the sample set, an initial memory location by an ordered selection process.

5. The method of claim 4, wherein the initial memory location of the ordered selection process is a least significant memory location of the memory.

6. The method of claim 4, wherein the initial memory location of the ordered selection process is a most significant memory location of the memory.

7. The method of claim 4, wherein the initial memory location of the ordered selection process is a last memory location accessed before an initiating event.

8. The method of claim 4, wherein the initial memory location of the ordered selection process has a lowestmost cycle count of all the memory locations of the memory at an initiating event.

9. The method of claim 8, wherein the initiating event is an idle period of the memory.

10. The method of claim 8, wherein the initiating event is power-up of the memory.

11. The method of claim 8, wherein the initiating event is expiration of a time duration.

12. The method of claim 8, wherein the initiating event is occurrence of a particular cycle count.

13. The method of claim 8, wherein the initiating event is initiating of a certain wear leveling routine.

14. The method of claim 4, wherein the method includes:
selecting as at least a portion of a subsequent sample subset of memory locations, a memory location located at an offset from the initial memory location selected by the ordered process of a prior sample subset;
selecting, at least in a substantially random manner, a number of memory locations as at least another portion of the subsequent sample subset, the subsequent sample subset including fewer than all of the memory locations of the memory;
identifying from among the subsequent sample subset of memory locations, a memory location having the particular wear level characteristic; and
writing data to the memory location identified from among the subsequent sample subset.

15. The method of claim 14, wherein the offset is one memory location.

16. The method of claim 15, wherein the offset is negative.

17. The method of claim 15, wherein the offset is incremented in a round robin manner so as to eventually include each one of all memory locations in a sample subset.

18. The method of claim 14 wherein each of the respective memory locations are a logical block address.

19. The method of claim 14, wherein each of the respective memory locations are a physical block address.

20. The method of claim 1, wherein data from an originating memory location is moved to the memory location identified from among the sample subset.

21. A method for wear leveling a memory, the method comprising:
selecting, in at least a substantially random manner, a number of memory locations of the memory as a random sample subset, the random sample subset including fewer than all of the memory locations of the memory;
selecting, by an ordered selection process, a number of memory locations of the memory as an ordered sample subset;
identifying from among the random sample subset and the ordered sample subset, a memory location having a lowestmost cycle count; and
writing data to the memory location identified from among the sample subset.

22. A method for wear leveling a memory, the method comprising:
determining, at power-up of the memory, cycle counts of all blocks on the memory;
including, in a first wear leveling operation after power-up, a block having the lowest cycle count of all blocks in a sample subset of blocks;
selecting, in at least a substantially random manner, an additional number of blocks into the sample subset, the additional number of blocks being substantially fewer than all blocks;
identifying from among the sample subset, a destination block having a lowestmost cycle count; and
writing data to the identified destination block.

23. The method of claim 22, wherein the data written to the identified destination block is moved from a block to be wear leveled.

24. The method of claim 22, wherein the method includes including, in the sample subset of blocks for wear leveling operations subsequent to the first wear leveling operation after power-up, a block selected by an ordered routine that will eventually include each block in a sample subset.

25. The method of claim 24, wherein the selection routine first selects a block having the lowestmost cycle count of all blocks at an initiating event.

26. The method of claim 24, wherein the routine selects a block having a logical block address adjacent the logical block address of a previously included block not selected in a substantially random manner into the sample subset.

27. The method of claim 26, wherein the routine selects each block at least once for inclusion in a respective sample subset.

28. The method of claim 27, wherein the routine includes selecting respective blocks in a round robin order.

29. The method of claim 22, wherein the method includes providing a statistically small percentage of all blocks in each sample subset.

30. The method of claim 22, wherein the method includes providing less than one percent of all blocks in each sample subset.

31. The method of claim 30, wherein the method includes providing approximately 0.25 percent of all blocks in each sample subset.

32. The method of claim 22, wherein the method includes providing a number of blocks that yield wear leveling performance within a given range of performance level with respect to a wear leveling performance expected where the destination block has a lowest absolute cycle count.

33. The method of claim 22, wherein each act of selecting, in at least a substantially random manner, is accomplished at least in part using a pseudo-random number generator.

34. The method of claim 33, wherein the method includes implementing the pseudo-random number generator in firmware.

35. The method of claim 33, wherein the method includes seeding the pseudo-random number generator using a value stored in the memory at an initiating event.

36. The method of claim 33, wherein the method includes implementing the pseudo-random number generator to provide a low correlation between selected blocks of a particular sample subset.

37. The method of claim 33, wherein the method includes implementing the pseudo-random number generator to provide a low correlation between selected blocks of different sample subsets.

38. The method of claim 33, wherein the method include selecting the block to be wear leveled by a static wear leveling process.

39. The method of claim 33, wherein the method includes selecting the block to be wear leveled by a dynamic wear leveling process.

40. A method for wear leveling a memory, the method comprising:
selecting a subset of all logical blocks, the subset including:
at least one logical block determined from an ordered selection process, the ordered selection process configured to select each logical block once before the ordered selection process selects any logical block for a second time, and
at least one logical block determined from at least a substantially random selection process;
determining from the subset of logical blocks, a corresponding subset of physical blocks;
identifying a lowest cycle count from among the subset of physical blocks; and
writing data to the identified physical block.

41. The method of claim 40, further comprising reading the data from an originating physical block and wherein writing data comprises writing the read data to the identified physical block.

42. The method of claim 40, wherein further comprising receiving the data from a host and wherein writing data comprises writing the received data to the identified physical block.

43. A memory device, comprising:
a memory having a number of memory locations; and
control circuitry coupled to the memory and configured to:
determine, from among a representative sample of the memory locations, a destination memory location having a lowestmost cycle count; and
write data to the destination memory location.

44. The memory device of claim 43, wherein the control circuitry is further configured to at least pseudo-randomly select a portion of the memory locations included in the representative sample.

45. The memory device of claim 44, wherein the control circuitry is further configured to include in the representative sample a memory location having an absolute lowestmost cycle count from among the number of memory locations at memory power-on.

46. The memory device of claim 43, wherein the control circuitry is further configured to include in the representative sample one memory location selected from among the number of memory locations by a round robin process, wherein the round robin process begins with the memory location having an absolute lowestmost cycle count from among the number of memory locations at memory power-on.

47. The memory device of claim 43, wherein the control circuitry is further configured to identify, in response to a wear leveling analysis, an originating memory location having the data to write.

48. The method of claim 43, wherein the control circuitry is further configured to determine and write in response to receiving the data from a host.

49. A memory device, comprising:
a number of FLASH memory arrays; and
control circuitry coupled to the FLASH memory arrays and configured to:
at least substantially randomly select a sample subset of fewer than all logical blocks associated with the FLASH memory arrays;
determine physical blocks corresponding to the logical blocks of the sample subset;
identify, from the determined physical blocks, a physical block having a lowestmost cycle count of the determined physical blocks; and
write data to the physical block identified as having have the lowestmost cycle count of the determined physical blocks.

50. The memory device of claim 49, wherein the control circuitry is further configured to move data from an originating physical block to the physical block determined to have the lowestmost cycle count of the determined physical blocks.

51. The memory device of claim 49, wherein the control circuitry is further configured to receive data from a host and write the read data to the physical block determined to have the lowestmost cycle count of the determined physical blocks.

52. The memory device of claim 49, wherein the control circuitry is further configured to select, as a portion of the sample set, a logical block corresponding to a physical block having a lowestmost cycle count at an initiating event.

53. The memory device of claim 52, wherein the initiating event is an idle period of the memory device.

54. The memory device of claim 52, wherein the initiating event is power-up of the memory device.

55. The memory device of claim 49, wherein the control circuitry is further configured to select as a portion of at least some sample subsets a logical block corresponding to a physical block located at a non-zero offset from a physical block having the lowestmost cycle count at an initiating event.

56. The memory device of claim 55, wherein the offset is different for each respective selection of a sample subset.

57. The memory device of claim 56, wherein the offset changes linearly by a fixed increment for each respective selection of a sample subset.

58. A memory controller, comprising:
a pseudo-random number generator; and
control circuitry in communication with the pseudo-random number generator and configured to:
select a number of logical blocks of a FLASH memory based on output of the pseudo-random number generator;
determine physical blocks corresponding to the selected logical blocks;
identify which of the determined physical blocks has a lowestmost cycle count of the determined physical blocks; and
write data to the physical block identified as having the lowestmost cycle count of the determined physical blocks in response to a wear leveling operation;
wherein for a first selection of logical blocks the lowestmost cycle count is an absolute lowestmost cycle count of all physical blocks of the FLASH memory, and wherein, for a selection of logical blocks subsequent to the first selection of logical blocks, the lowestmost cycle count can be larger than the absolute lowestmost cycle count.

59. The memory device controller of claim 58, wherein the control circuitry is configured to select at least one physical block by a non-random process, wherein for the first selection, the physical block having the lowestmost cycle count of all the physical blocks at power-up of the FLASH memory is selected.

60. The memory device controller of claim 59, wherein the non-random process is a linear process selecting physical blocks in a round-robin manner.
